(19) United States
(12) Patent Application Publication
(10) Pub. No.: US 2014/0240242 A1
(43) Pub. Date: Aug. 28, 2014

(54) SYSTEM AND METHOD FOR INTERACTING WITH A TOUCH SCREEN INTERFACE UTILIZING A HOVER GESTURE CONTROLLER

(71) Applicant: HONEYWELL INTERNATIONAL INC., Morristown, NJ (US)

(72) Inventors: Amit Nishikant Kawalkar, Bangalore (IN); Kiran Gopala Krishna, Bangalore (IN); Hans Roth, Phoenix, AZ (US)

(73) Assignee: HONEYWELL INTERNATIONAL INC., Morristown, NJ (US)

(21) Appl. No.: 13/777,737

(22) Filed: Feb. 26, 2013

(51) Int. Cl. G06F 3/041

(52) U.S. Cl. CPC G06F 3/0412
USPC 345/173

(57) ABSTRACT

A system and method are provided for employing a hover gesture controller to reduce inadvertent interactions with a touch screen. The hover gesture controller recognizes the user's interaction intentionality before physical contact is made with the touch screen. This reduces inadvertent user interactions and offloads a portion of computation cost involved in post touch intentionality reorganization. The hover gesture controller utilizes a touch screen interface onboard an aircraft coupled to a processor and configured to (a) detect a weighted hover interaction; and (b) compare the weighted hover interaction to a threshold value to determine if a subsequent touch is acceptable.

### TECHNICAL FIELD

Embodiments of the subject matter described herein relate generally to touch screen interfaces. More particularly, embodiments of the subject matter described herein relate to a system and method for reducing inadvertent touch and the effects thereof by utilizing a hover gesture controller.

### BACKGROUND

Touch screen interfaces are being adopted as the primary input device in a variety of industrial, commercial, aviation, and consumer electronics applications. However, their growth in these markets is constrained by problems associated with inadvertent interactions; which may be defined as any system detectable interaction issued to the touch screen interface without the user's consent. That is, an inadvertent interaction may be caused by bumps, vibrations, or other objects, resulting in possible system malfunctions or operational errors. For example, potential sources of inadvertent interactions include but are not limited to accidental brushes by a user's hand or other physical objects. Accidental interactions may also be caused by a user's non-interacting fingers or hand portions. Furthermore, environmental factors may also result in inadvertent interactions depending on the technology employed; e.g. insects, sunlight, pens, clipboards, etc. Apart from the above described side effects associated with significant control functions, activation of less significant control functions may degrade the overall functionality of the touch screen interface.

A known approach for reducing inadvertent interactions on a touch screen interface involves estimating the intent of the user to activate a particular control function by analyzing the users gaze or the size and duration of a contact with the touch screen interface. Unfortunately, such systems do not differentiate between functions having varying levels of operation significance. For example, in relation to an avionics system, certain control functions operate significant avionics functions (e.g. engaging the auto-throttle), while other control functions are associated with less significant functions (e.g. a camera video display). In addition, such approaches do not have the capability to evaluate the user's interaction intentionality before actual physical contact is made with the touch screen.

In view of the foregoing, it would be desirable to provide a system and method that utilizes one or more hover sensors and controller to recognize the user's interaction intentionality before physical contact is made with the touch screen. This would reduce inadvertent user interactions and would offload a portion of computation cost involved in post touch intentionality reorganization.

### BRIEF SUMMARY

This summary is provided to introduce a selection of concepts in a simplified form that are further described below in the detailed description. This summary is not intended to identify key or essential features of the claimed subject matter, nor is it intended to be used as an aid in determining the scope of the appended claims.

A method is provided for operating a touch screen interface. The method comprises detecting a weighted hover interaction and comparing the weighted hover interaction to a threshold value to determine if a subsequent touch is acceptable.

Also provided is a system for use onboard an aircraft. The system comprises a touch screen interface coupled to a processor that is configured to (a) detect a hover interaction; (b) generate the touch target acquisition dynamics description from a plurality of measurements associated with the user interaction; (c) determine the weighted hover interaction based on the comparison of the touch target acquisition dynamics description to the predetermined intentionality descriptor; and (d) compare the weighted hover interaction to a threshold value to determine if a subsequent touch is acceptable.

Furthermore, a method for operating a touch screen interface on an aircraft hover gesture controller is provided. The method comprises detecting a hover interaction and generating a touch target acquisition dynamics description from a plurality of measurements associated with the user interaction. The touch target acquisition dynamics description is compared to a predetermined intentionality descriptor to generate a weighted hover interaction. The weighted hover interaction is then compared to a threshold value to determine if a subsequent touch is acceptable.

### BRIEF DESCRIPTION OF THE DRAWINGS

FIG. 1 is a block diagram of an aircraft cockpit display system including a touch screen display and a touch screen controller;

FIG. 2 illustrates an exemplary touch pattern discrete signal profile corresponding to a user's positive intentions to produce a user interface element tap;

FIG. 3 illustrates an exemplary touch sensor parameter discrete signal profile corresponding to a user's accidental touch corresponding to negative intentionality;

FIG. 4 illustrates an exemplary touch sensor parameter discrete signal profile corresponding to an inadvertent tap;

FIG. 5 is a block diagram of a user interface containing a hover gesture controller, touch screen and hover sensor in accordance with an embodiment;

FIG. 6 is a flow chart of a touch target acquisition motion dynamics process in accordance with an embodiment;

FIG. 7 is a flow chart of a target zone sensitivity control process in accordance with an embodiment;

FIGS. 8 and 9 are exemplary embodiments of touch screens divided into regions with different associated threshold values; and

FIG. 10 is a flow chart of a hover gesture evaluation process in accordance with an embodiment.

### DETAILED DESCRIPTION

The following detailed description is merely illustrative in nature and is not intended to limit the embodiments of the subject matter or the application and uses of such embodiments. Any implementation described herein as exemplary is not necessarily to be construed as preferred or advantageous over other implementations. Furthermore, there is no intention to be bound by any expressed or implied theory presented in the preceding technical field, background, brief summary, or the following detailed description.

Techniques and technologies may be described herein in terms of functional and/or logical block components and with reference to symbolic representations of operations, processing tasks, and functions that may be performed by various computing components or devices. Such operations, tasks, and functions are sometimes referred to as being computer-executed, computerized, software-implemented, or computer-implemented. In practice, one or more processor devices can carry out the described operations, tasks, and functions by manipulating electrical signals representing data bits at memory locations in the system memory, as well as other processing of signals. The memory locations where data bits are maintained are physical locations that have particular electrical, magnetic, optical, or organic properties corresponding to the data bits. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

For the sake of brevity, conventional techniques related to graphics and image processing, touch screen displays, and other functional aspects of certain systems and subsystems (and the individual operating components thereof) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in an embodiment of the subject matter.

Disclosed herein is a novel hover gesture controller for use in conjunction with a touch screen interface, which reduces the inadvertent user interactions. This is accomplished through the use hover sensors placed around the perimeter of the touch screen that are coupled to the hover gesture controller. The hover gesture system enables users or developers to define user interaction requirements prior to physical contact with the touch screen interface. This extends the system beyond the limits of a particular operating system or application to which the user's inputs are directed. Presented herein for purposes of explication are certain exemplary embodiments of how the hover gesture system may be employed on a particular device. For example, the embodiment of an interface suitable for use in aviation applications will be discussed. However, it should be appreciated that this explicated example embodiment is merely an example and a guide for implementing the novel systems and method herein on any touch screen interface in any industrial, commercial, aviation, or consumer electronics application. As such, the examples presented herein are intended as non-limiting.

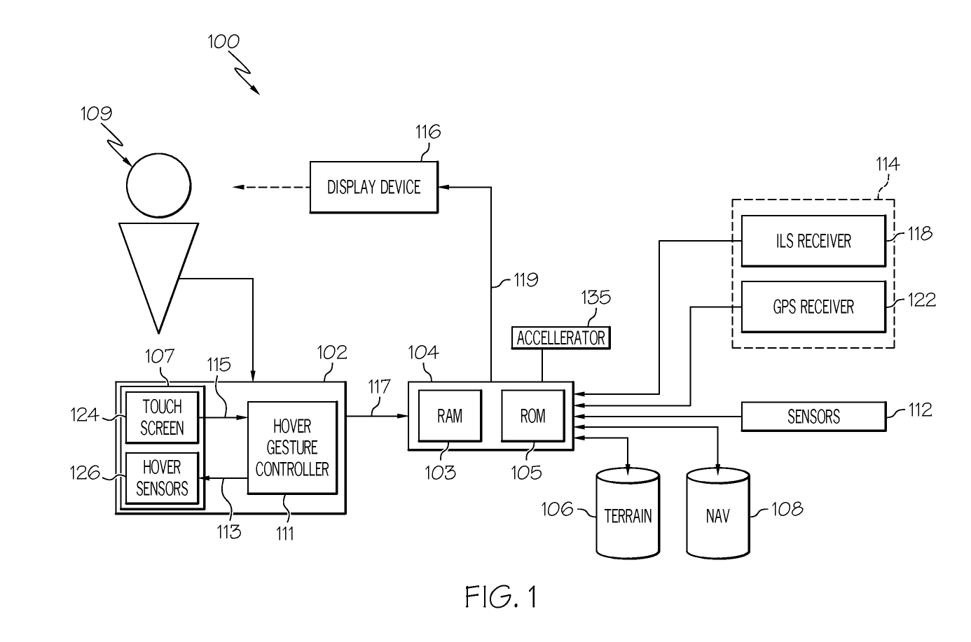

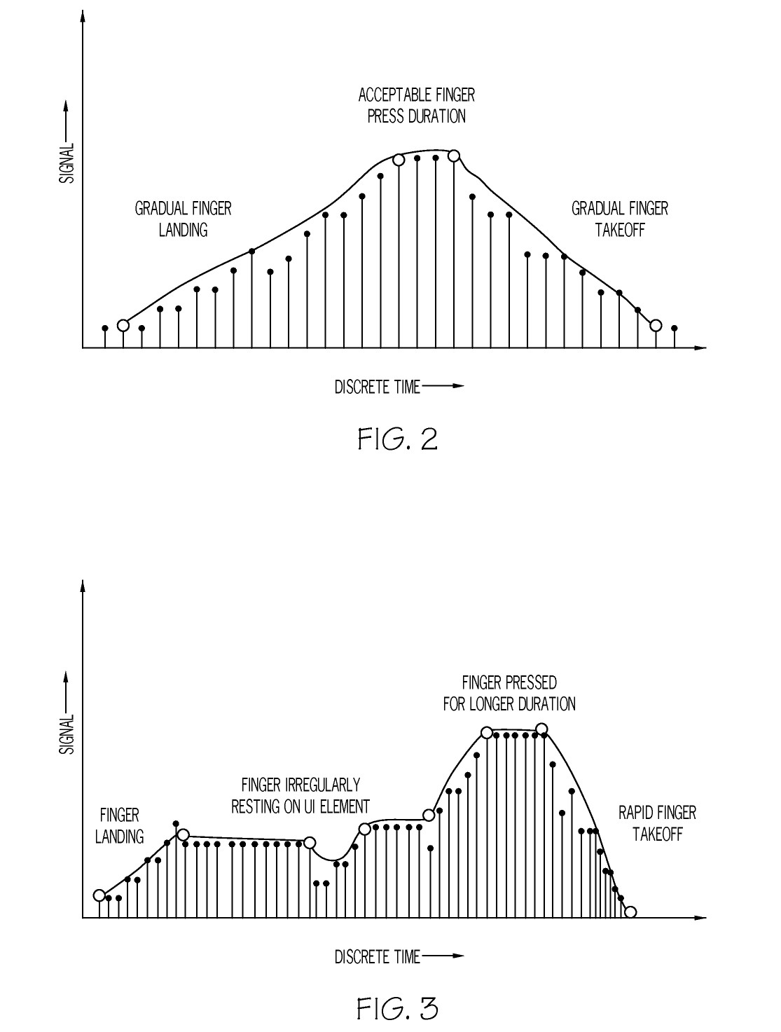

FIG. 1 illustrates a flight deck display system 100 includes a user interface 102, a processor 104, one or more terrain databases 106 sometimes referred to as a Terrain Avoidance and Warning System (TAWS), one or more navigation databases 108, sensors 112, external data sources 114, and one or more display devices 116. The user interface 102 is in operable communication with the processor 104 and is configured to receive input from a user 109 (e.g., a pilot) and, in response to the user input, supplies command signals to the processor 104. The user interface 102 may be any one, or combination, of various known user interface devices including, but not limited to, one or more buttons, switches, sensors or knobs (not shown). In the depicted embodiment, the user interface 102 includes a touch sensor 107 and a hover gesture controller (HGC) 111. The HGC 111 will fully be described below in connection with FIG. 2. HGC 111 provides drive signals 113 to a touch sensor 107, which is comprised of a touch screen 124 and hover sensor 126. A sense signal 115 is provided from the touch sensor 107 to the HGC 111, which periodically provides a control signal 117 of the determination of the touch sensor parameters to the processor 104. The processor 104 interprets the controller signal 117, determines the hover interactions and touch interactions. Therefore, the user 109 uses the touch sensor 107 to provide an input and the processing of the input is more fully described hereinafter.

The processor 104 may be implemented or realized with a general purpose processor, a content addressable memory, a digital signal processor, an application specific integrated circuit, a field programmable gate array, any suitable programmable logic device, discrete gate or transistor logic, discrete hardware components, or any combination designed to perform the functions described herein. A processor device may be realized as a microprocessor, a controller, a microcontroller, or a state machine. Moreover, a processor device may be implemented as a combination of computing devices, e.g., a combination of a digital signal processor and a microprocessor, a plurality of microprocessors, one or more microprocessors in conjunction with a digital signal processor core, or any other such configuration. In the depicted embodiment, the processor 104 includes on-board RAM (random access memory) 103, and on-board ROM (read-only memory) 105. The program instructions that control the processor 104 may be stored in either or both the RAM 103 and the ROM 105. For example, the operating system software may be stored in the ROM 105, whereas various operating mode software routines and various operational parameters may be stored in the RAM 103. The software executing the exemplary embodiment is stored in either the ROM 105 or the RAM 103. It will be appreciated that this is merely exemplary of one scheme for storing operating system software and software routines, and that various other storage schemes may be implemented.

The memory 103, 105 may be realized as RAM memory, flash memory, EPROM memory, EEPROM memory, registers, a hard disk, a removable disk, a CD-ROM, or any other form of storage medium known in the art. In this regard, the memory 103, 105 can be coupled to the processor 104 such that the processor 104 can be read information from, and write information to, the memory 103, 105. In the alternative, the memory 103, 105 may be integral to the processor 104. As an example, the processor 104 and the memory 103, 105 may reside in an ASIC. In practice, a functional or logical module/component of the display system 100 might be realized using program code that is maintained in the memory 103, 105. For example, the memory 103, 105 can be used to store data utilized to support the operation of the display system 100, as will become apparent from the following description.

No matter how the processor 104 is specifically implemented, it is in operable communication with the terrain databases 106, the navigation databases 108, and the display devices 116, and is coupled to receive various types of inertial data from the sensors 112, and various other avionics-related data from the external data sources 114. The processor 104 is configured, in response to the inertial data and the avionics-related data, to selectively retrieve terrain data from one or more of the terrain databases 106 and navigation data from one or more of the navigation databases 108, and to supply appropriate display commands to the display devices 116. The display devices 116, in response to the display commands, selectively render various types of textual, graphic, and/or iconic information.

The terrain databases 106 include various types of data representative of the terrain over which the aircraft is flying, and the navigation databases 108 include various types of navigation-related data. The sensors 112 may be implemented using various types of inertial sensors, systems, and or subsystems, now known or developed in the future, for supplying various types of inertial data, for example, representative of the state of the aircraft including aircraft speed, heading, altitude, and attitude. The ILS 118 provides aircraft with horizontal (or localizer) and vertical (or glide slope) guidance just before and during landing and, at certain fixed points, indicates the distance to the reference point of landing on a particular runway. The GPS receiver 124 is a multi-channel receiver, with each channel tuned to receive one or more of the GPS broadcast signals transmitted by the constellation of GPS satellites (not illustrated) orbiting the earth.

The display devices 116, as noted above, in response to display commands supplied from the processor 104, selectively render various textual, graphic, and/or iconic information, and thereby supplies visual feedback to the user 109. It will be appreciated that the display device 116 may be implemented using any one of numerous known display devices suitable for rendering textual, graphic, and/or iconic information in a format viewable by the user 109. Non-limiting examples of such display devices include various cathode ray tube (CRT) displays, and various flat screen displays such as various types of LCD (liquid crystal display) and TFT (thin film transistor) displays. The display devices 116 may additionally be implemented as a screen mounted display, or any one of numerous known technologies. It is additionally noted that the display devices 116 may be configured as any one of numerous types of aircraft flight deck displays. For example, it may be configured as a multi-function display, a horizontal situation indicator, or a vertical situation indicator, just to name a few. In the depicted embodiment, however, one of the display devices 116 is configured as a primary flight display (PFD).

In operation, the display device 116 is also configured to process the current flight status data for the host aircraft. In this regard, the sources of flight status data generate, measure, and/or provide different types of data related to the operational status of the host aircraft, the environment in which the host aircraft is operating, flight parameters, and the like. In practice, the sources of flight status data may be realized using line replaceable units (LRUs), transducers, accelerometers, instruments, sensors, and other well-known devices. The data provided by the sources of flight status data may include, without limitation: airspeed data; groundspeed data; altitude data; attitude data, including pitch data and roll data; yaw data; geographic position data, such as GPS data; time/date information; heading information; weather information; flight path data; track data; radar altitude data; geometric altitude data; wind speed data; wind direction data; etc. The display device 116 is suitably designed to process data obtained from the sources of flight status data in the manner described in more detail herein.

There are many types of touch screen sensing technologies, including capacitive, resistive, infrared, surface acoustic wave, and embedded optical. All of these technologies sense touch on a screen. A touch screen is disclosed having a plurality of buttons, each configured to display one or more symbols. A button as used herein is a defined visible location on the touch screen that encompasses the symbol(s). Symbols as used herein are defined to include alphanumeric characters, icons, signs, words, terms, and phrases, either alone or in combination. A touch-sensitive object as used herein is a touch-sensitive location that includes a button and may extend around the button. Each button including a symbol has a touch-sensing object associated therewith for sensing the application of the digit or digits.

An inadvertent touch may result from the accidental brush by pilot's hand or any physical object capable of issuing detectable touch to the touch sensor, while the pilot is not actually interacting with the touch controller. Such kinds of inadvertent touches may be issued while moving across the flight deck or due to jerks induced by the turbulence. In addition, accidental touch may result from the pilot's non-interacting fingers or hands; e.g. if the pilot is interacting with the system using the pilot's index finger, and the pilot's pinky finger, which is relatively weak, accidentally touches a nearby user interface element.

Some inadvertent touches are caused by environmental factors that depend upon the touch technology used in the system; e.g. electromagnetic interference in capacitive technologies; and insects, sunlight, pens etc. with optical technologies. Ideally, all touches not intentionally issued by the pilot or crew member should be rejected; however, this would not be practical. A practical solution should consider the seriousness of an inadvertent touch and subsequent activation of the control function; some may have a relatively minor effect and others may have a more significant effect. In addition, the control function interface interaction characteristics (time on task, workload, accessibility, ease of use etc.) should remain equivalent to the interface available in non-touch screen flight decks or through alternate control panels. If special interaction methods are employed for portions of the user interface, then the interaction method should be intuitively communicated to the pilot, without the need for additional training or interaction lag. Mandatory interaction steps, which would increase the time on task and reduce interface readiness of the touch interfaces, should not be added.

It is known that various technologies and methods exist to reduce inadvertent interactions with touch screens. Such methods include: tracking a user's gaze, comparing received touch profiles to predefined profiles, utilization of visual cues, or touch stability measured over the duration of the touch event. Some of these methods are described in brief detail below to illustrate that there is a gap in a solution to reduce inadvertent interactions prior to the user making contact with the touch screen.

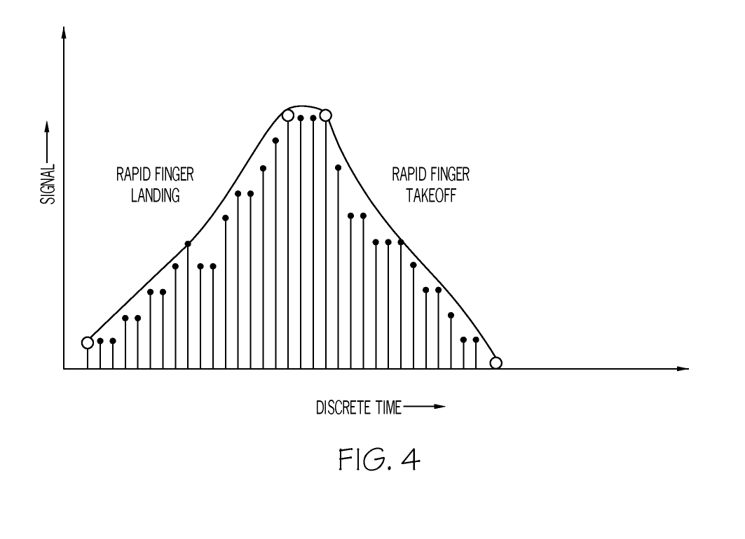

A known method for reducing inadvertent interactions may compare the received touch profile to a predetermined touch profile. This may be implemented by obtaining the signal values from the touch screen and dividing the signal values into N zones corresponding to N different threshold values. For an interaction to be a valid one, a corresponding rule or pattern for the measured input signals is defined. The input signal pattern is then compared to the predefined rule or pattern. If the measured input signal pattern falls within the tolerance limits of the predefined input signal pattern, then corresponding interaction is accepted and passed to the underlying software application. For example, referring to FIG. 2, an input signal profile corresponding to a “TAP” gesture interaction is displayed, which follows a specific and predictable pattern. That is, the profile shown in FIG. 2 is characterized by an initial gradual finger landing, followed by an acceptable finger press duration that is, in turn, followed by a gradual finger removal. The rules can be further defined through experimentation to determine a reasonably constant signal stream pattern for a given gesture or interaction to be positively intentional. FIG. 3, however, shows a rather unpredictable profile that corresponds to a user's accidental touch. As can be seen, the profile in FIG. 3 comprises a finger landing, irregularly resting on a user interface element, a finger pressed for a longer duration, and finally on rapid finger takeoff. FIG. 4 illustrates an exemplary touch sensor parameter discrete signal profile corresponding to an inadvertent tap characterized by a rapid finger landing and a rapid finger takeoff, also indicative of a user's negative intention.

Overall, as described by the above method, the user interactions are only rejected after physical contact is made with the touch screen. However, the exemplary embodiment described herein helps to address the issue of inadvertent interactions by allowing for the system to determine if the interaction was inadvertent prior to physical contact with the touch screen. This exemplary embodiment may be used with other known inadvertent interaction rejection methods and would strengthen the overall intentionality recognition process. In addition, the exemplary embodiment would offload a portion of computing cost involved in post touch processing by rejecting some of the user interaction before physical contact was made with the touch screen.

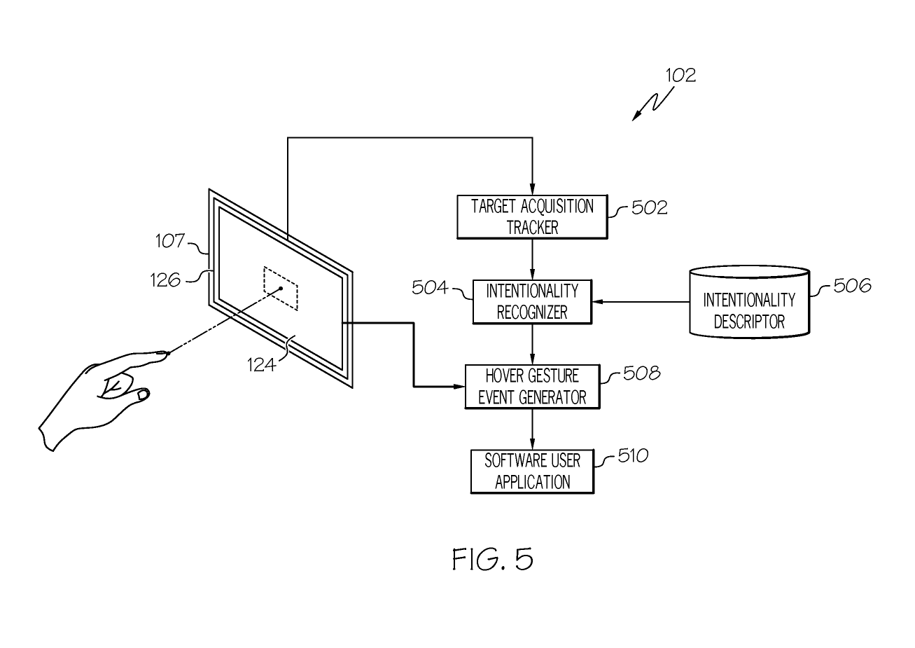

FIG. 5 is a block diagram of a user interface 102 containing a hover gesture controller 111 (FIG. 1), touch screen 124, and hover sensor 126 in accordance with an embodiment. A touch screen 124 and hover sensors 126 generate hover interactions and touch interactions in response to a user interaction. The hover interactions are comprised of user interactions prior to the user contacting the touch screen and are characterized by various parameters such as distance, velocity, acceleration, and hand/finger three-dimensional position. These measurements are taken by the hover sensors and are sent to a target acquisition tracker 502. The target acquisition tracker 502 constructs a touch target acquisition dynamics description from the corresponding measurements taken by the hover sensors 126. The target acquisition tracker 502 further derives and associates other parametric information such as velocity, acceleration, three-dimensional position, and hover duration with the touch target acquisition dynamics description. The derived touch target acquisition dynamics description is then sent to an intentionality recognizer 504.

Intentionality recognizer 504 compares the touch target acquisition dynamics description to predefined parameters stored in the intentionality descriptor database 506. The predefined parameters correspond to experimentally defined user interactions with the user interface 102. Various factors will be accounted for when determining the predefined parameters including environmental conditions, touch screen technologies, and user interaction requirements. Based upon the comparison, the intentionality recognizer 504 associates a weighted value that acts as an indicator of how strong or weak the input matched a valid touch target acquisition dynamics description. The weighted result is then sent to the hover gesture event generator 508.

The hover gesture event generator 508 generates a touch event by evaluating the weighted result and associates it with the touch interactions, if a touch event is performed on the touch screen 124. The touch interactions are comprised only of user interactions during the time the user is in contact with the touch screen. If the weighted result is below a threshold value, the user interaction will be classified as accidental and will be rejected. However, if the weighted result is greater than the threshold value, then the hover gesture event generator 508 passes the user interaction to the underlying software user application 510. The threshold value may be increased or decreased depending on which control function the user is intending to activate. For example, the threshold value may be increased if the touch target corresponds to a control function that has a high significance level (e.g. auto pilot, engine throttle, or radio frequency). However, the threshold value may be decreased if the touch target corresponds to a control function that has a low significance level (e.g. page turn, screen zoom, or screen brightness). In addition, the hover gesture event generator 508 may activate regions of the touch screen (124, FIG. 1) in response to the predicted location of the user interaction. Furthermore, the size of the activated regions may be reduced as the user approaches the touch screen to perform the user interaction.

The touch event is then passed to the underlying software user application 510. The touch event is processed in accordance to known methods for reducing inadvertent interactions with a touch screen interface. Some of the known methods have been described above, such as, tracking a user's gaze, comparing received touch profiles to predefined profiles, utilization of visual cues, or touch stability measured over the duration of the touch event. However, it should be appreciated that these are merely examples of some known methods for reducing inadvertent interactions with a touch screen and are not intended to be limiting.

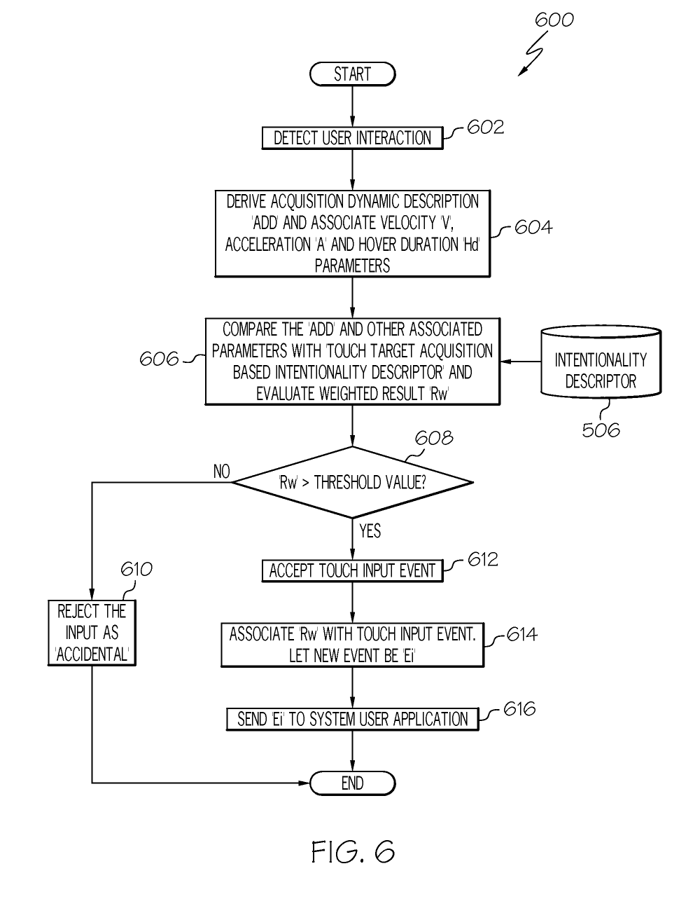

FIG. 6 is a flow chart 600 of a touch target acquisition motion dynamics process in accordance with an embodiment. The process utilizes the touch screen 124 and hover sensors 126 to detect user interactions within 10 millimeters of the touch screen. At this range, the intentionality of the user interaction can be recognized with sufficient confidence and with a low amount of noise. The process begins with receiving the user interaction with the user interface device (STEP 602). In STEP 604, a touch target acquisition dynamic description is derived from the user interaction and associated with velocity, acceleration, and hover duration parameters. The touch target acquisition dynamic description is then compared with the intentionality descriptor database 506 to determine a weighted result in STEP 606. The weighted result is compared to a threshold value in STEP 608. If the weighted result is less than the threshold value then the user interaction is rejected (STEP 610). However, if the weighted result is greater than the threshold value then the touch input event is accepted (STEP 612). In STEP 614, the weighted result is associated with the touch input event and sent to the system user application in STEP 616.

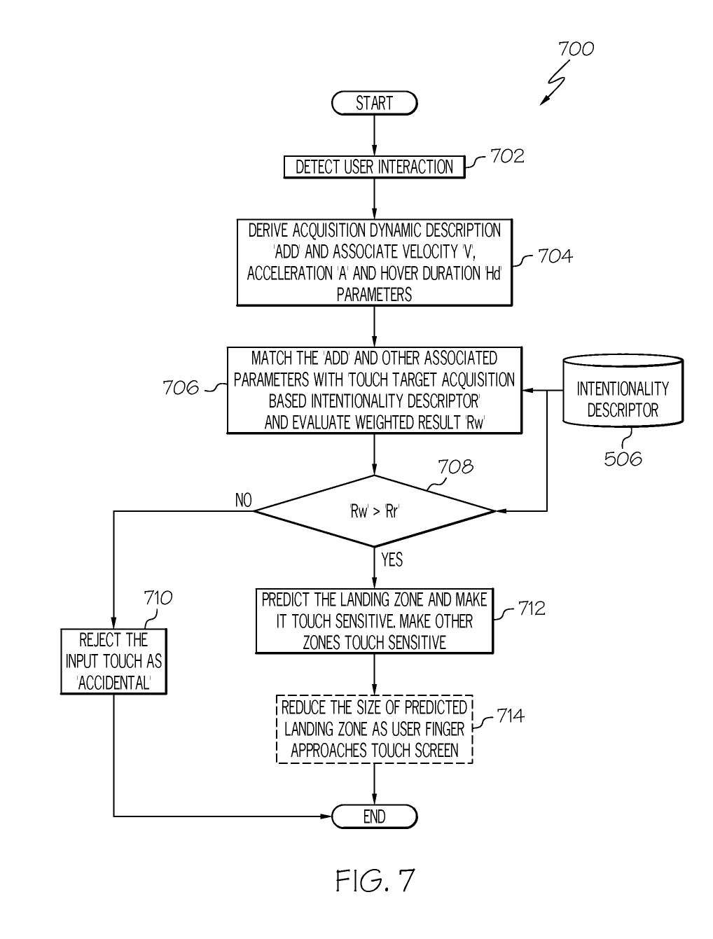

FIG. 7 is a flow chart of a target zone sensitivity control process 700 in accordance with an embodiment. This process builds on the process described in FIG. 6, by adding long range depth hover sensors to detect and track user interactions up to a distance of one foot from the user interface. This allows the system to evaluate and predict an instantaneous location (i.e. landing zone) of the user's interaction with the touch screen. The process commences with receiving the user interaction with the user interface device (STEP 702). In STEP 704, a touch target acquisition dynamic description is derived from the user interaction and associated with velocity, acceleration and hover duration parameters. The touch target acquisition dynamic description is then compared with the intentionality descriptor database 506 to determine a weighted result (STEP 706). The weighted result then is compared to a threshold value (STEP 708). The threshold values for regions on the touch screen may increase or decrease depending on various factors including the user interface, task model, turbulence, significance of control functions, location, size or as desired by the system designer. If the weighted result is less than the threshold value then the user interaction is rejected (STEP 710). However, if the weighted result is greater than the threshold value, the predicted landing zone is activated to become touch sensitive while the rest of the touch screen is deactivated becoming touch insensitive (STEP 712). In addition, the size and corresponding touch sensitive region of the landing zone may be decreased as the user approaches the touch screen to perform the user interaction in STEP 714.

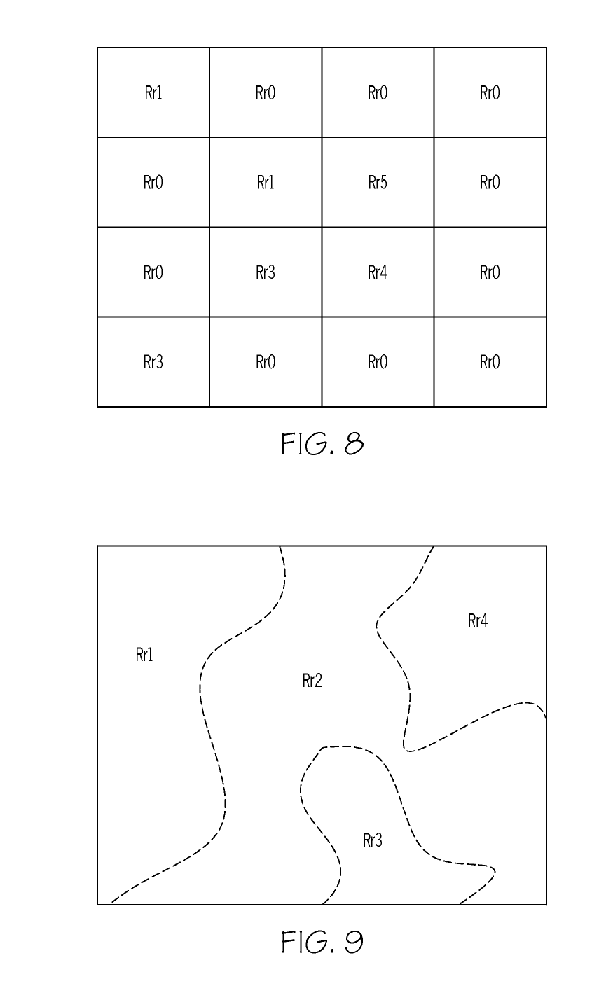

FIGS. 8 and 9 are exemplary embodiments of touch screens divided into regions with different associated threshold values. FIG. 8 illustrates a touch screen divided into sixteen equally regions with threshold weights ranging from Rr0 to Rr5. Regions that contain low significance control functions (e.g. page turn, screen zoom, or screen brightness) could have a threshold weight of Rr0. However, regions that contain high significance control functions (e.g. auto pilot, engine throttle, or radio frequency) are more likely to have threshold weights of Rr4 or Rr5. In addition, FIG. 9 illustrates that the regions of the touch screen may be irregularly shaped allowing for the system designer more flexibility in tailoring the regions to fit the factors that affect the threshold values.

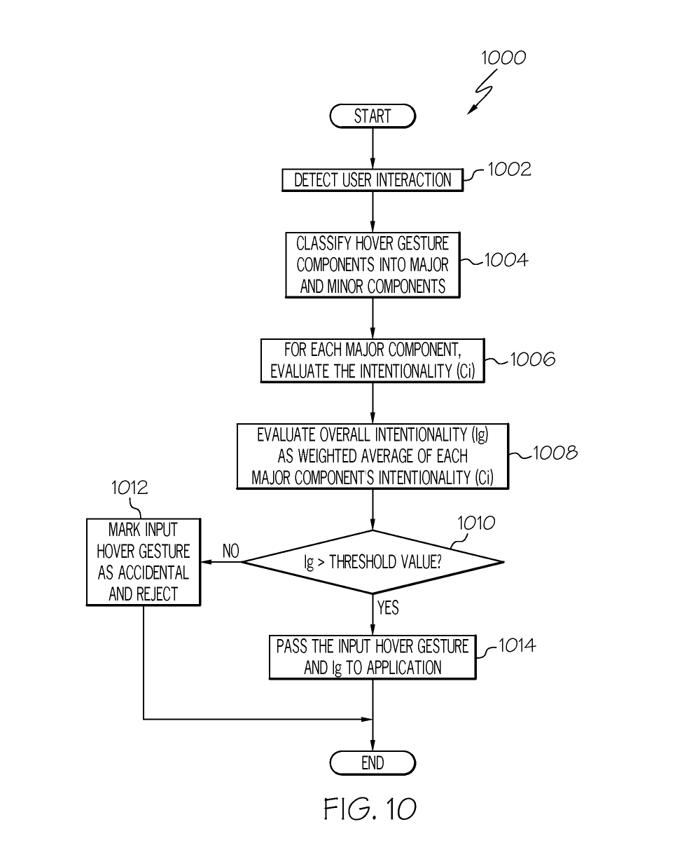

FIG. 10 is a flow chart 1000 of a hover gesture evaluation process in accordance with an embodiment. This process may be used to reject user interactions prior to the user interacting with the touch screen. The process begins with detecting the user interaction in STEP 1002 and classifying the hover gesture components into major and minor components (STEP 1004). For example, in a pinch in-pinch out gesture, the dynamic component corresponding to a thumb could be treated as a major component, while other fingers would be treated as minor components. In STEP 1006, the intentionality is evaluated for each of the major components of the hover gesture. The overall intentionality is then determined as a weighted average of each major component's intentionality (STEP 1008). In STEP 1010, the overall intentionality is compared to a threshold value. If the overall intentionality is less than the threshold value then the user interaction is marked as accidental and rejected in STEP 1012. However, if the overall intentionality is greater than the threshold value then the touch input event is accepted and sent to the system user application (STEP 1014).

Thus, there has been provided a novel hover gesture controller for use in conjunction with a touch screen interface, which reduces the possibility of inadvertent user interactions. This is accomplished through the use of hover sensors placed around the perimeter of the touch screen that are coupled to the hover gesture controller. The hover gesture system enables system developers to define interaction requirements prior to user contact with the touch screen interface to strengthen the overall intentionality recognition process. In addition, the exemplary embodiment would offload a portion of computing cost involved in post touch processing by rejecting some interaction before physical contact was made with the touch screen. Furthermore, this method reduces inadvertent interactions, while the control function interface interaction characteristics (time on task, workload, accessibility, ease of use etc.) remains equivalent to the interface available in non-touch screen flight decks or through alternate control panels.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims.

What is claimed is:

1. A method for operating a touch screen interface, the method comprising:
detecting a weighted hover interaction; and
comparing the weighted hover interaction to a threshold value to determine if a subsequent touch is acceptable.

2. The method of claim 1 wherein the step of detecting the weighted hover interaction, comprises:
detecting a touch target acquisition dynamics description;
comparing the touch target acquisition dynamics description with a predetermined intentionality descriptor; and
generating a weighted hover interaction based on the comparison of the touch target acquisition dynamics description to the predetermined intentionality descriptor.

3. The method of claim 2 wherein the step of deriving an touch target acquisition dynamics description, comprises:
detecting a user interaction with a hover sensor; and
generating the touch target acquisition dynamics description from a plurality of measurements associated with the user interaction.

4. The method of claim 3 wherein the measurements comprise distance and velocity of the user interaction with the touch sensor.

5. The method of claim 3 wherein the measurements comprise acceleration and three-dimensional hand/finger position of the user interaction with the touch sensor.

6. The method of claim 3 wherein the measurements comprise size and hover duration of the user interaction with the touch sensor.

7. The method of claim 1 wherein the step of comparing the weighted hover interaction to a threshold value, comprises:
determining if the weighted hover interaction is less than a threshold value; and
rejecting the weighted hover interaction as an accidental user interaction.

8. The method of claim 1 wherein the step of comparing the weighted hover interaction to a threshold value, comprises:
determining if the weighted hover interaction is greater than a threshold value; and
predicting the location of the user interaction with the touch screen.

9. The method of claim 8 further comprises associating higher threshold value for activating control functions of greater significance.

10. The method of claim 8 further comprises generating a touch sensitive region at the predicted location of the user interaction, while all regions of the touch screen remain touch insensitive.

11. The method of claim 8 further comprises reducing the size of the predicted location of the user interaction as the user approached the touch screen.

12. The method of claim 1 wherein the step of comparing the weighted hover interaction to a threshold value, comprises:
determining if the weighted hover interaction is greater than a threshold value; and
outputting a touch event to the underlying system application.

13. The method of claim 12 where the touch event is comprised of both hover interactions and a touch interactions.

14. A hover gesture controller system onboard an aircraft, comprising:
a touch screen interface; and
a processor configured to (a) detect a hover interaction; (b) generate a touch target acquisition dynamics description from a plurality of measurements associated with the user interaction; (c) determine a weighted hover interaction based on the comparison of the touch target acquisition dynamics description to a predetermined intentionality descriptor; and (d) compare the weighted hover interaction to a threshold value to determine if a subsequent touch is acceptable.

15. The system according to claim 14 wherein the processor is further configured to reject the weighted hover interaction as an accidental user interaction, if the weighted hover interaction is less than the threshold value.

16. The system according to claim 14 wherein the processor is further configured to:
predicted the location of the user interaction with the touch screen, if the weighted hover interaction is greater than the threshold value; and
generate a touch sensitive region at the predicted location of the user interaction, while all regions of the touch screen remain touch insensitive.

17. The system according to claim 16 wherein the processor is further configured to reduce the size of the predicted location of the user interaction as the user approached the touch screen.

18. A method for operating a touch screen interface on an aircraft hover gesture controller, comprising:
detecting a hover interaction;
generating a touch target acquisition dynamics description from a plurality of measurements associated with the user interaction;
determining a weighted hover interaction based on the comparison of the touch target acquisition dynamics description to a predetermined intentionality descriptor; and
comparing the weighted hover interaction to a threshold value to determine if a subsequent touch is acceptable.

19. The method of claim 18 further comprises rejecting the weighted hover interaction as an accidental user interaction, if the weighted hover interaction is less than a threshold value.

20. The method of claim 18 further comprises:
predicting the location of the user interaction with the touch screen, if the weighted hover interaction is greater than a threshold value; and
generating a touch sensitive region at the predicted location of the user interaction, while all regions of the touch screen remain touch insensitive.
